(19) United States
(12) Patent Application Publication
(10) Pub. No.: US 2004/0130571 A1
(43) Pub. Date: Jul. 8, 2004

(54) Method and apparatus for interactive entertainment

(76) Inventor: Don W. White, Deming, NM (US)

Correspondence Address: Matthew S. Wermager, PO Box 1888, Albuquerque, NM, 87103, US

(21) Appl. No.: 10/337,116

(22) Filed: Jan. 6, 2003

(51) Int. Cl. G09G 5/00

(52) U.S. Cl. 345/751

(57) ABSTRACT

The method and apparatus for interactive entertainment in which the audience interacts with the entertainment it is viewing. The audience is informed of pre-determined personality traits and objectives to which the actors of the entertainment must adhere. If a member of the viewing audiences notices that any of the actors of the entertainment diverge from those pre-determined personality traits or objectives, that member of the viewing audience communicates this divergence to a control responsible for the content of the entertainment and the audience member then participates personally in the entertainment and the diverging actor of the entertainment is removed from further participation.

### FIELD OF THE INVENTION

The present invention relates to an interactive entertainment method and apparatus for facilitating such entertainment. In one embodiment, the present invention relates to a broadcast of media containing recorded real time images of people reacting to situations and broadcasting these images either simultaneously or at a subsequent time to a viewing audience. Another embodiment of the present invention relates to a broadcast of media in which the actors are computer generated and broadcasted to a viewing audience. Still another embodiment of present invention relates to live performances in front of viewing audiences that are physically present at the performance location. The viewing audience in all embodiments has the opportunity to interact with the control of the entertainment and replace at least one actor in the entertainment or assume responsibility for that actor and control that actor vicariously. The member of the viewing audience that replaces an actor is subsequently prone to being replaced by a different member of the viewing audience.

### BACKGROUND OF THE INVENTION

Reality based television programs have become a very popular form of television based entertainment. These reality shows are based on the general premise that ordinary people are placed into an unusual, unnatural, or any kind of publicly viewed environment. These shows subject people to a variety of situations and focus on these people's reactions to the situations. These reactions are often an indication of each person's ability to react and adjust to these situations. These reactions are recorded onto media and are the subject of a television broadcast. These programs will often involve a competitive component whereby individuals who are the basis of the broadcast (i.e. the “actors”) often vie for rewards or similar benefits and are rewarded on the basis of their reactions to the environments in which they are placed.

More recently, these reality televisions programs have included an interactive element in that the viewing audience of the broadcast can communicate either through telephonic or Internet means to the show's producers or other entity having some responsibility for the content of such shows. The communication is usually some expression of opinion as to the direction in which further installments of the show should proceed. However, this communication, although repeatable, is the extent of a member of the viewing audience's opportunity to interact with any aspect of the broadcast. In addition, the opinion expressed is subjectively based on personal tastes and preferences of the viewer (e.g., who is a better singer or a better athlete) with little, if any, extrinsic factors or guidelines set in advance of the programs's broadcast.

Similarly, computer games, which by their very nature are interactive, have been a popular form of entertainment for decades. These computer games range from two-way interaction (between only the player and the computer), to a universal interaction, whereby a plurality of players, through the use of a centralized server, can compete against each other and/or the computer. These players control characters in a computer-generated environment and can coordinate with or compete against each other in an infinitely broad variety of situations.

In addition, live stage performances can often include an interactive element. For example, in improvisational performances of a comedic nature, the actors often interact with the audience of that performance, and occasionally allow for a member of the viewing audience to participate on-stage with the performers for a relatively short period of time.

While the above described television shows, computer programs and stage performances comprise what would be considered interactive environments, there is no way known to the inventor for a viewer to (1) physically replace the subject of the broadcast, (2) assume control of someone else's representation of an actor in a computer generated environment, or (3) physically replace a stage performer. U.S. Pat. No. 6,447,396 to Gaylean, II, et. al. describes a television broadcast of an interactive computer game, but does not describe any method by which the players of the game being broadcast are selected. Nor does the patent describe any method for a viewer of the broadcast to assume control of another player's actor. U.S. Pat. No. 6,443,840 to Von Kohom describes a method of audience participation in the form of wagering on the outcomes of certain television shows, but again, does not describe any method by which a member of the audience can actually become an actor in the show being wagered on. Finally, there is nothing in the prior art that combines the extemporaneous nature of the reality television shows and computer games, much less a truly interactive experience, with live stage performances.

Therefore, there is a need for an interactive entertainment method and apparatus whereby a member of the viewing audience can not only interact with the participants of a broadcast or performance, but also can personally replace a participant. This system would be a truly interactive experience in that the audience member not only perceives the actions of the participants of the broadcast or performance, but also replaces or assumes the role of that participant and thus becomes a participant in the broadcast or performance.

Definitions

The party or entity responsible for at least a portion of the content of the entertainment will hereafter be referred to as the “control”.

The people (both real and representations thereof) portraying characters that are the subject of the entertainment will hereafter be referred to as the “actors”. The term “actor” should not be construed to mean that the people portraying characters that are the subject of the entertainment are merely reading from a script, although this may be the case.

“Entertainment” should be construed to comprise either a broadcast of media containing recorded images of people reacting to situations or a live performance of people reacting to situations in front of a viewing audience whether or not those reactions are recorded.

### OBJECTS OF THE INVENTION

It is an object of the present invention to provide a method and apparatus for interactive entertainment that allows members of a viewing audience to replace, either personally or vicariously, the actors of the entertainment.

It is another object of the present invention to provide a method and apparatus for the communication of information to the viewing audience describing required personality traits and objectives which define the outer boundaries of permissible action for at least some of the actors of the entertainment.

It is yet another object of the present invention to provide a method and apparatus for interaction between the viewing audience and the control.

It is still yet another object of the present invention to provide a method and apparatus for the broadcast of the entertainment to a viewing audience.

It is still yet another object of the present invention to provide for an Internet based method and apparatus having the objects as set forth above.

It is a further object of the present invention to utilize the Internet or other electronic communication to facilitate communication to an from the viewing audience and control.

It is a further object of the present invention to utilize the Internet to broadcast the media.

It is further object of the present invention to provide a method for the replacement of at least one actor of the entertainment with at least one member of a viewing audience that is physically present at the performance of the entertainment.

The foregoing and other objects will be apparent from the drawings and the description set forth herein.

### SUMMARY OF THE INVENTION

This invention relates to interactive entertainment. In one embodiment, the invention relates to a method and apparatus for an interactive media broadcast in which actors can be replaced by members of the viewing audience. In a different embodiment, the invention relates to a method for the replacement of actors in a live stage performance Both embodiments include a plurality of groups comprised of one or more actors reacting to pre-defined situational hypotheticals. The actors are supposed to react to the situations in a manner according to pre-defined character and personality traits. The reactions of the actors are either perceived by a viewing audience directly or are recorded onto some communicable media that is then transmitted and received by a viewing audience.

In the interactive media broadcast embodiment, the communicable media includes any medium capable of recording real time images, and can be film, digital or any other format that can be transmitted. The interactive media broadcast further includes one or more apparatuses for recording and either simultaneously (“live”) or at a later date (“pre-recorded”), transmitting the media. The means for transmitting the media includes VHF broadcasting, UHF broadcasting, cable lines, fiber optic lines, microwave, satellite, physical transportation of the medium (including computer game cartridges or video cassettes), or any other appropriate means which is well known in the art. In the media broadcast embodiment, the transmission is communicated to an appropriate viewing audience, such as a television audience or a computer user accessing an appropriate website.

In the stage performance embodiment, no apparatus is necessary as the actors are perceived by a viewing audience that is physically in the actor's presence. However, the apparatus of the previous embodiment can be used to record and broadcast the entertainment.

In all embodiments, the invention includes a method and apparatus to inform the viewing audience of pre-defined personality and character traits of the group and the plurality of actors that initially define such groups. The viewing audience will reference the pre-defined traits to assess if the actors are acting in accordance with those pre-defined traits. If an actor deviates from the pre-defined traits, that actor will be considered an offending actor. Once a member of the viewing audience identifies an offending actor, such member will report the offending actor to the control. The reporting member of the audience will then replace the offending actor and either assume their role in the entertainment or be given different pre-defined personality traits and objectives to portray.

The invention further relates to the method and apparatus described above with regard to the interactive media broadcast embodiment except that the actor in the broadcast is a computer-generated representation of an individual, avatar or other character. A computer user controls the computer-generated actor. The viewing audience member views the interaction of the actors in the same way as described above with reference to the media broadcast embodiment, but does not personally replace the actor in the broadcast but rather assumes control of the actor in the media broadcast.

The invention in all embodiments described above retains the common feature that a member of the viewing audience can replace an actor in the entertainment. The member of the viewing audience may assume the personality traits and objectives of the offending actor, or may be given new traits and objectives to which the new actor must adhere to avoid being considered an offending actor. The number of actors in the entertainment will be limited by the number of groups required for a certain situation, and the number of actors required in the groups.

### BRIEF DESCRIPTION OF THE DRAWINGS

FIG. 1 is a block schematic diagram of the present invention illustrating the communication of the pre-defined personality traits and situational hypotheticals to the viewing audience and to the groups of actors. FIG. 1 further illustrates the recording of the actor's reactions and communicating those actions to a viewing audience.

FIG. 2 is a block diagram of the present invention illustrating the selection a member of the viewing public to interact with the control of the entertainment for the purpose of replacing the offending actor.

FIG. 3 is a block diagram illustrating the replacement of an offending actor in the broadcast with a member of the viewing audience. FIG. 3 further illustrates the possibility of returning the offending actor to the viewing audience.

### DESCRIPTION OF THE PREFERRED EMBODIMENTS

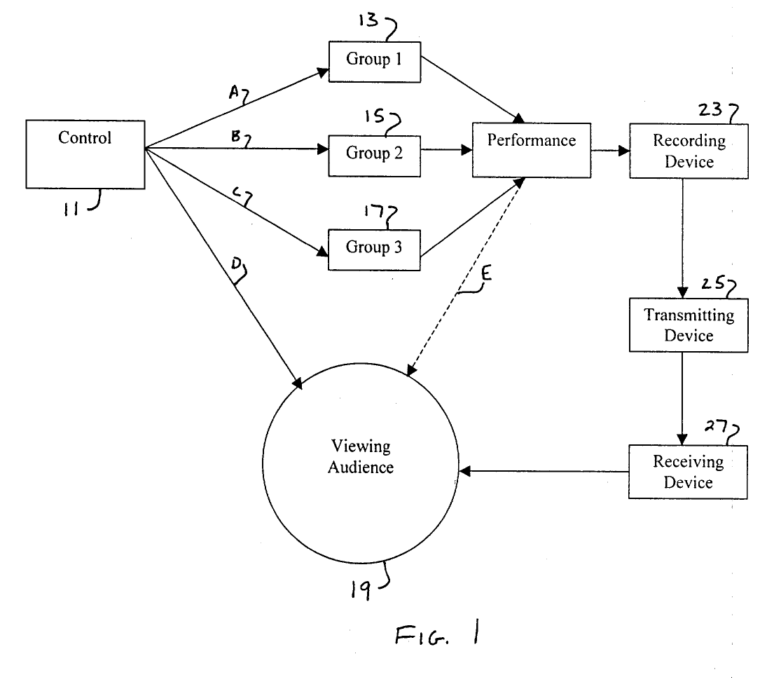

The interactive entertainment method and apparatus is disclosed with reference to FIG. 1. Control 11 can be any entity responsible for the content of the interactive entertainment. Control 11 (or some other third party) can initially select one or more groups of people to be actors. In one embodiment, as illustrated, the control has established and identified three different groups of actors 13, 15, and 17. Control 11 will also have established pre-defined personality traits and pre-defined objectives for the groups of actors 13, 15, and 17. Control 11 will communicate these traits and objectives to the groups of actors and to a viewing audience 19 as schematically indicated by arrows A, B, C, and D. This communication can be achieved through any variety or combination of means. In one embodiment, the communication is accomplished through use of the Internet and a designated web site. In another embodiment, the communication is accomplished through use of a written communication accompanying a designated consumer product or service. In another embodiment, the communication is accomplished through radio or television based communication. In still another embodiment, the communication is accomplished through the use of direct written or verbal communication from the control to the viewing audience.

FIG. 1 further illustrates the performance, and the method and apparatus of broadcasting the actions of the groups of actors 13, 15, and 17 to the viewing audience 19. The broadcast method and apparatus includes a recording device 23, a transmitting device 25, and a receiving device 27. In operation, the recording device will capture and record the actions of the groups of actors 13, 15, and 17 and record these actions onto some communicable media. This media is then transmitted by a transmitter device 25 and received by a receiver device 27. This transmission from the transmitter device 25 to the receiver device 27 can be accomplished via cable lines, fiber optic lines, UHF transmissions, VHF transmissions, microwave transmissions, satellite transmissions, physical transportation of the medium (including computer game cartridges or video cassettes), or any other appropriate transmittal device. Appropriate devices for both the transmitter device and receiver device are chosen according the type of communicable media and type of transmission being utilized. In one embodiment, the recording, transmitting and receiving by the viewing audience 19 can all be conducted simultaneously (e.g. a “live” broadcast). In another embodiment, the recording is completed before transmitting the communicable media via the transmitting device 25 to the receiving device 27 (e.g. a “pre-recorded” broadcast).

With regard to FIG. 1, the live stage performance embodiment will eliminate the need for recording device 23, transmitting device 25, and receiving device 27 as the performance will be perceivable by the viewing audience 19 due to their physical presence at the performance as schematically indicated by broken line E. However, recording device 23, transmitting device 25 and receiving device 27 may still be utilized to record and broadcast the performance to a different viewing audience.

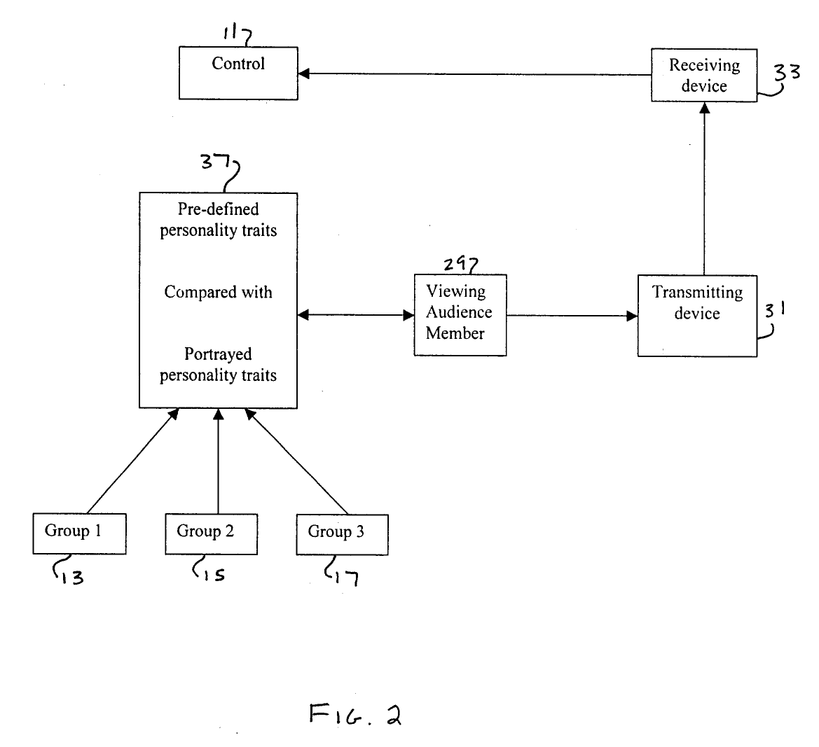

The interactive entertainment is further illustrated in FIG. 2. As the viewing audience 19 perceives the broadcast disclosed with reference to FIG. 1, the members of the viewing audience 19 compare, as indicated by reference 37, the actions, personalities, and objectives of the groups of actors 13, 15, and 17 to the pre-defined personalities and objectives communicated to them by control 11. The first viewing audience member to identify a difference and communicate this difference to control 11 is indicated by reference 29. This communication can be accomplished by transmitting this communication with a transmitting device 31 to a receiving device 33. Transmitting device 31 and receiving device 33 can be any combination of telephones, computers coupled with the Internet, and/or facsimile machines. In a different embodiment, this communication can be a verbal or written communication communicated directly to the control when the control and the audience are in the presence of each other.

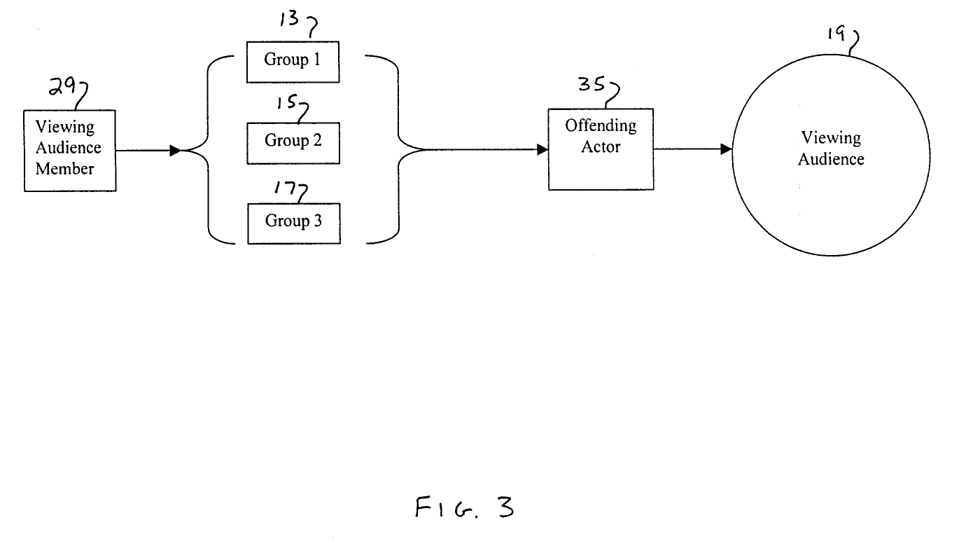

FIG. 3 illustrates the replacement of at least one member of one of the groups of actors 13, 15 and 17 with a member of the viewing audience member 29. With reference the FIG. 3, the first viewing audience member 29 who correctly identifies a difference between the portrayed actions, personalities, or objectives of an offending actor 35 and the pre-defined personality traits and objectives as illustrated in FIG. 2, will take the place of the offending actor 35 in one of the groups of actors 13, 15 and 17. The offending actor 35 may then return to the viewing audience 19 or may be precluded from further involvement at the discretion of the control 11.

With reference to FIGS. 1, 2 and 3, the groups of actors 13, 15 and 17 can either be real people in real world situations or can be avatars or some other representation of a character in a computer generated setting. In the case of real people in real world situations, the member of the viewing audience 29 chosen to replace the offending actor 35 will physically take that actor's place. In the case of computer generated characters in a computer generated setting, the member of the viewing audience 29 will assume vicarious control of the actor previously controlled by the offending actor 35.

This method for the interactive entertainment will continue until a time pre-determined by the control. Until that time, the performance will continue and any member of the groups of actors 13, 15, and 17, including actors that were previously members of the viewing audience 19, may be replaced by a different member of the viewing audience 19 for the reasons set forth above.

For illustrative purposes only, a sample description of one embodiment of the invention is described. The groups of actors will consist of the law, the outlaws, and the mercenaries. The ultimate objective is the delivery and a a payroll shipment from Dodge City, Kans. to Tombstone, Ariz. The payroll shipment in this particular embodiment represents the reward for the successful group of actors. Once the money reaches Tombstone, it will be placed into a bank where it will need to be protected for one week. After that week, the money will be transported by wagon to a small town, where it will be placed in a different bank before being dispersed to the payees.

Participants will originally be chosen by the control to be actors at the outset of the broadcast. These actors will be divided into one of the three groups described above. The group that is the law has the principal objective of protecting the money. The group that is the outlaws has the principal objective of stealing the money. Finally the group that is the mercenaries has the principal objective of capturing the outlaws. Each actor in each group will be given the personality traits appropriate for the group to which that actor is assigned but may differ from other actors in that group. This same information will be communicated to the viewing audience. In one embodiment of the invention, the information would be given to the public through access to a web site. In another embodiment, this information would be communicated to the public by attaching the communication to some designated consumer product or service so that only those purchasing such designated product or service would have access to this information.

The groups of actors would then prepare for and begin to carry out their objective(s). The actors' reactions to the objectives and actions of other actors would be recorded onto some kind of communicable media. In one embodiment of this invention, a television camera whose function and use is well known to one in the art, would be utilized to capture the actions of the groups. This recorded media can then be either simultaneously transmitted to the viewing audience who would perceive the show with a standard television set. In another embodiment, the recorded media could be broadcast to the viewing audience at a later date. In still yet another embodiment, the actions of the groups of actors could be captured onto some form of media, which is capable to be read by inputted into a computer. In this embodiment, the viewing would be able to perceive the recorded media via access to a web site. For example, one broadcast may show the outlaws attempting to break into the train protected by the law, while being pursued themselves by the mercenaries.

The viewing audience would then watch for deviations between the pre-defined objectives and personality traits and those as actually portrayed by the actors. For example, if an outlaw were one that had a trait of non-violence yet participated in gunfight with the law, this actor would be an offending actor. If a viewer recognizes a deviation, he would communicate that deviation to the control. This communication can be accomplished through the telephones, computers coupled to the Internet, facsimile machines, or any combination thereof. Control would then remove the offending actor and replace that actor with a member of the viewing audience. This member of the viewing audience subsequently becomes an actor who is prone to being replaced by a different member of the viewing audience.

These events will continue through a plurality of shows, with the possibility of at least one actor being replaced with at least one member of the viewing audience. The actors who comprise the group that completes its objective at the time the control determines is appropriate for the show's termination will be given the reward.

Whereas the drawings and accompanying description have shown and described the preferred embodiment, it should be apparent to those skilled in the art that various changes may be made in the form of the invention without affecting the scope thereof.

What I claim is:

1. A method of interactive entertainment, comprising:
a. providing a plurality of groups, at least one of said groups containing a plurality of people;
b. providing each of said people with one or more pre-defined personality traits to portray as an actor;
c. providing said actors with one or more pre-defined objectives pertaining to one or more situational hypotheticals;
d. recording onto a communicable media the actions of said actors in said hypotheticals;
e. transmitting said communicable media to a viewing audience;
f. communicating to said viewing audience said pre-defined personality traits;
g. comparing, by said viewing audience, said pre-defined personality traits with the personality traits portrayed by said actors;
h. identifying from one or more of said groups all or some said actors deviating from said pre-defined personality traits;
i. communicating to a control said actors deviating from said pre-defined personality traits;
j. removing by said control from one or more said groups all or some said actors deviating from said pre-defined personality traits; and
k. replacing each of said removed actors with a member of said viewing audience responsible for said identification and communication of said identification to said control.

2. The method of interactive entertainment of claim 1, wherein said pre-defined objectives of each said group are adverse to at least some of the other said groups.

3. The method of interactive entertainment of claim 1, further including the step of communicating to said viewing audience said pre-defined objectives.

4. The method of interactive entertainment of claim 2, further including the step of identifying from one or more of said groups all or some said actors deviating from said pre-defined objectives.

5. The method of interactive entertainment of claim 3, further including the step of replacing from one or more of said groups all or some said actors deviating from said pre-defined objectives with a member of said viewing audience responsible for identifying said deviating actor.

6. The method of interactive entertainment of claim 2, wherein said communicating to said viewing audience said pre-defined personality traits and said pre-defined objectives allows immediate interaction between said viewing audience and said control.

7. The method of interactive entertainment of claim 2, wherein said communicating to viewing audience said pre-defined personality traits and said pre-defined objectives is accomplished through a communication accompanying any purchase of a designated product or service.

8. The method of interactive entertainment of claim 7, further including the step of providing a unique identifier to accompany said any purchase of said designated product or service and requiring the use of said unique identifier to initiate said communication of actor deviation.

9. The method of interactive entertainment of claim 2, wherein said communicating said pre-defined personality traits and said pre-defined objectives is independent of said transmitting said communicable media to said viewing audience.

10. The method of interactive entertainment of claim 1, further including the step of receiving said communicable media via a receiver device capable of displaying said transmitted communicable media.

11. The method of interactive entertainment of claim 1, wherein said transmitting of said communicable media allows immediate interaction between said viewing audience and said control.

12. The method of interactive entertainment of claim 1, further including the step of selecting said people from a group including human beings, computer generated characters, user generated characters, textual representations or avatars.

13. A method of live interactive entertainment comprising:
a. providing a plurality of groups, at least one of said groups containing a plurality of people;
b. providing each of said people with one or more pre-defined personality traits to portray as an actor;
c. providing said actors with one or more pre-defined objectives pertaining to one or more situational hypotheticals;
d. communicating to a viewing audience said pre-defined personality traits;
e. comparing, by said viewing audience, said pre-defined personality traits with the personality traits portrayed by said actors;
f. identifying from one or more said groups all or some said actors deviating from said pre-defined personality traits;
g. communicating to a control said actors deviating from said pre-defined personality traits;
h. removing from one or more said groups all or some said actors deviating from said pre-defined personality traits; and
i. replacing each of said removed actors with a member of said viewing audience responsible for said identification and communication of said identification to an entity responsible for controlling said replacement.

14. The method of interactive entertainment of claim 13, wherein said pre-defined objectives of each said group are adverse to at least some of the other said groups.

15. The method of interactive entertainment of claim 13, further including the step of communicating to said viewing audience said pre-defined objectives.

16. The method of interactive entertainment of claim 14, further including the step of identifying from one or more of said groups all or some said actors deviating from said pre-defined objectives.

17. The method of interactive entertainment of claim 15, further including the step of replacing from one or more of said groups all or some said actors deviating from said pre-defined objectives with a member of said viewing audience responsible for identifying said deviating actor.

18. The method of interactive entertainment of claim 14, wherein said communicating to viewing audience said pre-defined personality traits and said pre-defined objectives is accomplished through direct verbal or written communication.

19. The method of interactive entertainment of claim 14, wherein said communicating to viewing audience said pre-defined personality traits and said pre-defined objectives is accomplished through a communication accompanying any purchase of a designated product or service.

20. The method of interactive entertainment of claim 19, further including the step of providing a unique identifier to accompany said any purchase of said designated product or service and requiring the use of said unique identifier to initiate said communication of actor deviation.

21. The method of interactive entertainment of claim 13, further including the step of recording and transmitting said entertainment to a second viewing audience.

22. An interactive media broadcast comprising:
a. a plurality of groups each containing one or more people, said people portraying actors according to pre-defined personality traits, said actors attempting to accomplish pre-defined objectives pertaining to situational hypotheticals;
b. a recording device capable of converting real time images onto communicable media, said recording device recording said actor's attempts onto said communicable media;
c. a transmittal device capable of transmitting said communicable media;
d. a receiver device capable of receiving and displaying said transmitted communicable media;
e. means for communicating said pre-defined personality traits and said pre-defined objectives to the public;
f. means for communicating actor deviation from said pre-defined personality traits and said pre-defined objectives from the public; and
g. means for replacing a deviating actor with a member of public.

23. The interactive media broadcast of claim 22, wherein said pre-defined objectives of each said group is adverse to some or all of other said groups.

24. The interactive media broadcast of claim 22, wherein said transmittal device is a computer coupled with the Internet.

25. The interactive media broadcast of claim 24, wherein said receiver device is a computer coupled with the Internet.

26. The interactive media broadcast of claim 22, wherein said transmittal device is selected from the group consisting of cable lines, fiber optic lines, microwave transmissions, satellite transmission and/or physical transportation in the form of data cartridges.

27. The interactive media broadcast of claim 26, wherein said receiver device is a television.

28. The interactive media broadcast of claim 22, wherein said means for communicating said pre-defined personality traits and said pre-defined objectives to the public is the Internet.

29. The interactive media broadcast of claim 22, wherein said means for communicating pre-defined personality traits and pre-defined objectives to public is selected from the group consisting of cable lines, fiber optic lines, microwave transmissions and/or satellite transmission.

30. The interactive media broadcast of claim 22, wherein said means for communicating said pre-defined personality traits and said pre-defined objectives accompanies any purchase of a designated product or service.

31. The interactive media broadcast of claim 30, further including a unique identifier to accompany any said purchase of said designated product or service to initiate said communication of actor deviation.

32. The interactive media broadcast of claim 22, wherein said communication of said pre-defined personality traits and said pre-defined objectives is via a means independent of said transmittal of communicable media.

33. The interactive media broadcast of claim 22, wherein said means for communicating character deviation from the public is via the Internet.

34. The interactive media broadcast of claim 22, wherein said means for communicating character deviation from the public is telephonic including facsimile.

35. The interactive media broadcast of claim 22, wherein said people are human beings, computer generated characters, user generated characters, textual representations or avatars.
